(19) United States
(12) Patent Application Publication
(10) Pub. No.: US 2008/0024313 A1
(43) Pub. Date: Jan. 31, 2008

(54) Retail shopping facility and associated method of operation

(76) Inventor: Sheldon M. Gordon, Greenwich, CT (US)

Correspondence Address: COLEMAN SUDOL SAPONE, P.C., 714 COLORADO AVENUE, BRIDGE PORT, CT, 06605-1601, US

(21) Appl. No.: 11/879,174

(22) Filed: Jul. 16, 2007

Related U.S. Application Data
(60) Provisional application No. 60/833,584, filed on Jul. 27, 2006.

(51) Int. Cl. G01W 1/00

(52) U.S. Cl. 340/601

(57) ABSTRACT

In a retail shopping facility having spaces with respective store fronts disposed along a pedestrian right of way, the right of way is maintained open to the ambient environment during hospitable weather conditions and enclosed to form an enclosed common space upon a passing of a temperature threshold by ambient temperatures. Roof structures are moved to cover the pedestrian right of way prior to the operation of a heating or air conditioning system.

### CROSS-REFERENCE TO RELATED APPLICATION

This application claims the benefit of U.S. Provisional Patent Application No. 60/833,584 filed Jul. 27, 2006.

### BACKGROUND OF THE INVENTION

This invention relates to a retail shopping facility. This invention also relates to a method of operating such a facility.

Shopping malls currently come in two varieties, the closed mall and the open mall. In a closed mall, the entire retail shopping space is enclosed in a single space that is temperature and climate controlled. In contrast, in an open mall, the common space between the various stores is outside, subject to the ambient environment. These types of malls have their respective advantages and disadvantages. The closed mall is homogenous, stuffy, uninteresting and dull.

While the outdoors type of mall provides an enjoyable experience in times of hospitable weather, times of inclement weather can considerably curtail customers' shopping trips, thereby reducing retailers' sales.

Another problem with closed malls is their utilization of large amounts of energy for the HVAC processes. This energy use is viewed by environmentalists as excessively damaging to the environment.

### OBJECTS OF THE INVENTION

It is an object of the present invention to provide an improved mall or shopping facility.

Another, more specific, object of the present invention is to provide a mall or shopping facility that incorporates advantages of closed malls and open malls, while obviating disadvantages thereof.

A further object of the present invention is to provide an improved method of operating a retail shopping facility such as a mall.

These and other objects of the present invention will be apparent from the drawings and detailed descriptions herein. While every object of the invention is believed to be attained in at least one embodiment of the invention, there is not necessarily any single embodiment that achieves all of the objects of the invention.

### SUMMARY OF THE INVENTION

The present invention is directed in part to a method for operating a retail shopping facility comprising a plurality of retail spaces defined by respective enclosures and having respective store fronts disposed along a pedestrian right of way. The method comprises maintaining the pedestrian right of way open to the ambient environment during hospitable weather conditions, enclosing the pedestrian right of way to form an enclosed common space upon a passing of a temperature threshold by ambient temperatures, and while the pedestrian right of way is enclosed, operating an air temperature control system to maintain the enclosed common space within a predetermined temperature range.

The pedestrian right of way may be a corridor, a walkway, a road with or without sidewalks, etc. In the case of a road or street, the ends of the road or street are preferably blockaded to vehicular traffic. Also in the case of a road or street, the storefronts may take the form of conventional store fronts on streets or roads.

Pursuant to another feature of the present invention, the enclosing of the pedestrian right of way includes automatically shifting a roof structure from a neutral position to a position covering the pedestrian right of way. The roof structure may be supported on a track so that the shifting of the roof structure includes rolling, sliding or otherwise moving the roof structure along rails.

The enclosing of the pedestrian right of way may further include forming vertical walls along ends of the pedestrian right of way. The vertical walls may be panels slid sideways from building structures on one or both sides of the right of way. Alternatively, the vertical walls may be flexible sheets that are suspended from the roof structure upon the positioning thereof over the pedestrian right of way. The flexible sheets may be unfurled from respective storage rolls carried by the roof structure.

A retail shopping facility comprises, in accordance with the present invention, (a) a plurality of retail spaces defined by respective enclosures and having respective store fronts disposed along a pedestrian right of way, and (b) a roof structure shiftable between a closed position wherein at least part of the roof structure extends over the pedestrian right of way to enclose the pedestrian right of way along an upper side thereof and an open position wherein the roof structure is disposed out of vertical alignment with the pedestrian right of way, whereby the pedestrian right of way is open to the ambient environment from above. The shopping facility further comprises (c) a drive mechanism operatively coupled to the roof structure and (d) a control unit operatively connected to the drive mechanism for activating same to shift the roof structure from the open position to the closed position at an onset of inclement weather and to shift the roof structure from the closed position to the open position upon a termination of inclement weather. In addition, (e) an air temperature control system communicates with pedestrian right of way for maintaining same within a predetermined temperature range, while the roof structure is in the closed position.

The pedestrian right of way may be a first pedestrian right of way, with the shopping facility further comprising a plurality of additional retail spaces defined by respective enclosures and having respective store fronts disposed along a second pedestrian right of way communicating with the first pedestrian right of way. An additional roof structure may be permanently disposed over the second right of way, the second pedestrian right of way being open to the ambient environment during hospitable weather. Means are provided in that case for isolating the second pedestrian right of way from the ambient environment upon occasions of inclement weather, the air temperature control system communicating with second pedestrian right of way for maintaining same together with the first pedestrian right of way within the predetermined temperature range

The additional roof structure may include a balloon structure with at least two substantially co-extensive sheets or film members, a pressurization source being connected to the balloon structure for alternately pressurizing and depressurizing a space between the sheets or film members.

Preferably, but not necessarily, the air temperature control system includes an environmentally friendly energy source such as solar energy collectors, wind power generators, geothermal power generators, and hydroelectric turbines.

Pursuant to further features of the present invention, the roof structure is at least partially disposed on at least some of the enclosures, the roof structure is disposed on a plurality of rails, vertical wall structures are movably disposed to alternately open and close off ends of the pedestrian right of way.

### BRIEF DESCRIPTION OF THE DRAWINGS

FIG. 1 is s n architectural floor plan of a mall in accordance with the present invention.

FIGS. 2A through 2C are schematic cross-sectional view taken along line II-II in FIG. 1, showing alternative position of a movable roof structure, in accordance with the present invention.

FIG. 3 is a schematic perspective view of a trusswork for the roof structure of FIGS. 2A 20 through 2C.

FIG. 4 is a schematic cross-sectional view taken along line IV-IV in FIG. 1, showing a roof structure with balloon components.

FIG. 5 is a schematic cross-sectional view, on a larger scale, of a roof balloon shown in FIG. 4, showing the balloon in one operational configuration.

FIG. 6 is a schematic cross-sectional view, similar to FIG. 5, showing the balloon in another operational configuration.

FIG. 7 is a block diagram of operative components of the mall of FIG. 1, pursuant to the present invention.

FIG. 8 is a plan view of the mall of FIG. 1 in a landscape.

### DETAILED DESCRIPTION

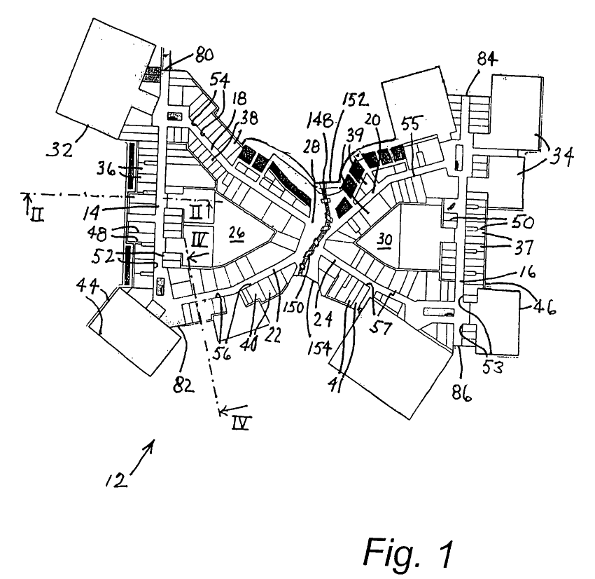

The present disclosure contemplates a retail shopping facility that is neither a conventional enclosed shopping mall nor a traditional open air mall. Instead, a shopping mall 12 such as that exemplarily depicted in FIG. 1 provides multiple pedestrian rights of way including outdoor shopping streets 14 and 16, naturally ventilated covered walkways 18, 20, 22, 24, and atria 26, 28, and 30.

During times of pleasant weather conditions, streets 14 and 16, walkways 18, 20, 22, 24, and optionally atria 26, 28, and 30 are at least partially open to the ambient environment. During times of inclement or inhospitable weather conditions, streets 14 and 16, walkways 18, 20, 22, 24, and atria 26, 28, and 30 are enclosed and artificially ventilated (heated or air conditioned). Such a shopping mall 12 is a “green” or environmentally_friendly facility insofar as the energy required for climate control is minimized. The environmental friendliness of mall 12 may be further augmented by the use of “green” energy, such as solar or wind power, etc. In addition, the shopping experience is enhanced by providing ready customer access to the out-of doors during fine weather and by sheltering the customer and providing climate control in unpleasant weather conditions.

The shopping mall 12 of FIG. 1 comprises a plurality of retail spaces housing anchor stores 32 and 34 and smaller retail outlets 36-41. Retail outlets or stores 36 and 37 are located along streets 14 and 16, respectively, while retail outlets or stores 38-41 are located along respective customer walkways 18, 20, 22, and 24. The retail spaces housing anchor stores 32 and 34 and smaller outlets 36-41 are defined by respective enclosures such as outer walls 44 and 46, firewalls 48 and 50, and store fronts 52-57 disposed along streets 14 and 16 and walkways 18, 20, 22, 24.

In operating mall 12, one maintains at least some of the pedestrian rights of way, such as streets 14 and 16, open to the ambient environment during hospitable weather conditions. In addition, one encloses streets 14 and 16, walkways 18, 20, 22, 24, and atria 26, 28, and 30 to form an enclosed common space upon a passing of a temperature threshold by ambient temperatures. While streets 14 and 16, walkways 18, 20, 22, 24, and atria 26, 28, and 30 are enclosed, an air temperature control system including one or more HVAC units 60 is operated to maintain the enclosed common space within a predetermined temperature range.

In cooler climates, the temperature threshold is typically a low-temperature threshold, so that heating is effectuated upon closure of streets 14 and 16 and walkways 18, 20, 22, 24. In warmer climates, the temperature threshold is typically a relatively high-temperature threshold, so that air-conditioning (cooling) is effectuated upon closure of streets 14 and 16 and walkways 18, 20, 22, 24.

The particular threshold selected may vary in accordance with the time of year and local sensibilities. For example, where the local denizens are used to temperatures below freezing in winter months, mall enclosure and heating may be triggered at a temperature between 30° F. and 45° F. and where the winter temperatures are generally above freezing, the threshold temperature may be in a range from 40° F. to 55° F. Alternatively, where local summer climate conditions are hot and humid, a temperature threshold for mall enclosure and cooling may be set at a lower temperature, say 80° F. to 90° F., than where the summer climate is hot and dry, and there in a range from 85° F. to 95° F.

Streets or roads 14 and 16 may be open to traffic, but can be blocked or barricaded during pleasant weather to ensure a pedestrian right of way. Streets 14 and 16 are blocked during inclement or inhospitable weather conditions, owing to the closure of the streets to enable air temperature control. Store fronts 52 and 53 may take the form of conventional store fronts on streets or roads.

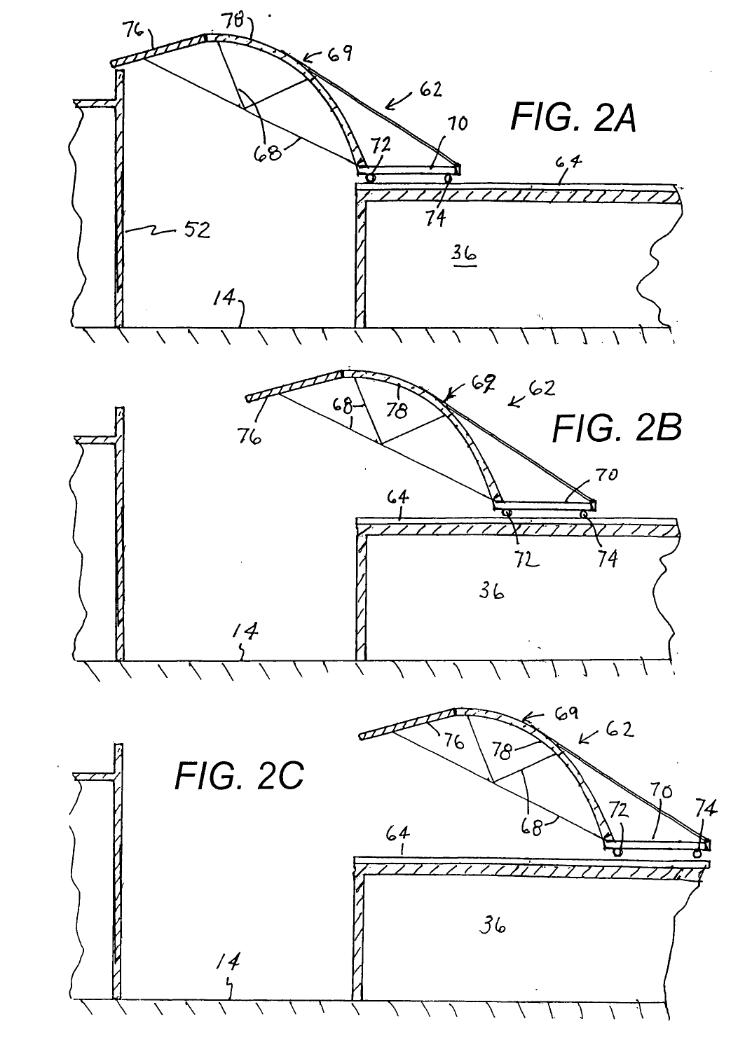

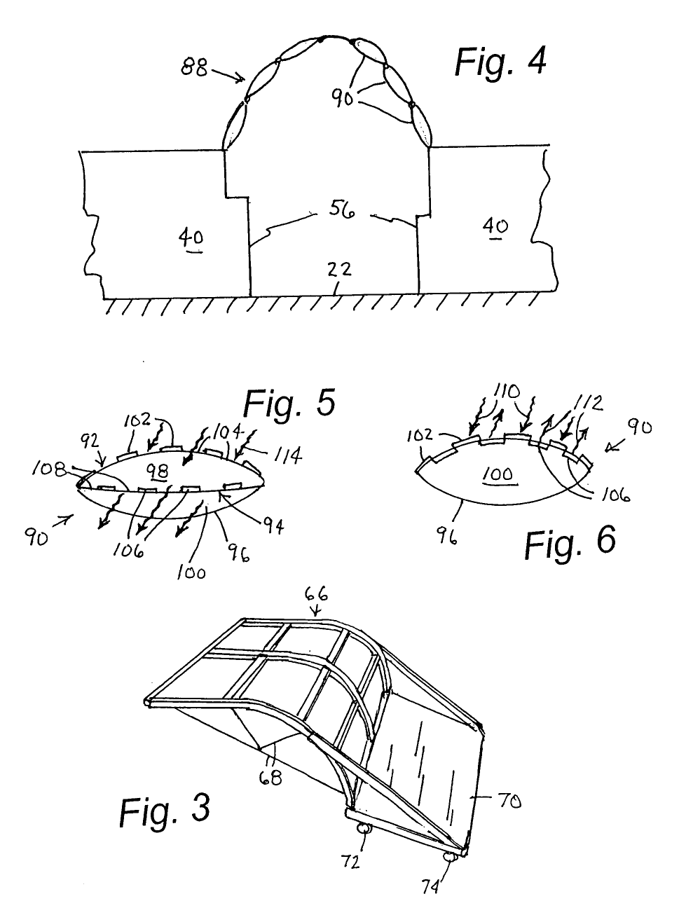

The enclosing of streets 14 and 16 is effectuated in part by automatically shifting a plurality of roof structures 62 (FIGS. 2A-2C, 3) from a neutral position (FIG. 2B or 2C) to a position (FIG. 2A) covering streets 14 and 16. Roof structures 62 are supported on tracks or rails 64 (in turn supported on the roofs of retail outlets or stores 36 and 37) so that the shifting of the roof structures is accomplished by rolling, sliding or otherwise moving the roof structures along the tracks or rails. More specifically, each roof structure 62 includes a trusswork 66 (FIG. 3), wire stays 68 and a covering 69 of suitable lightweight material such a polycarbonate. Roof structure 62 further includes a carriage 70 with front wheels 72 and rear wheels 74. Rear wheels 74 may be rotationally locked to tracks or rails 64 to prevent tipping of trusswork 66.

Covering 69 may include an opaque section 76 and a transparent section 78. FIG. 2C shows a fully retracted position of roof structure 62, that may be used particularly in autumn and spring seasons in cooler climates. FIG. 2B shows a partially extended position of roof structure 62 where opaque section 76 is disposed partially over street 14 or 16 to function as a shade or sun-block.

The enclosing of streets 14 and 16 may further include moving vertical walls 80 and 82 (FIG. I) to close respective ends (not separately labeled) of street 14 and moving walls 84 and 86 to close respective ends of street 16. Walls 80, 82, 84, 86 may take the form of panels slid sideways from building structures on one or both sides of streets 14 and 16. Alternatively, walls 80, 82, 84, 86 maybe sheets or panels that are lowered and suspended from terminal roof structures 62 upon the positioning thereof over streets 14 and 16. In the case of flexible sheets, the sheets may be unfurled from respective storage rolls (not shown) carried by the end or terminal roof structures 62.

As shown in FIG. 4, walkways 18, 20, 22, 24 may be covered year-round with a roof structure 88 (preferably a trusswork) carrying a plurality of inflatable pillow-shaped air bags 90.

Air bags 90 may be elongate and extend parallel to walkways 18, 20, 22, 24. As shown in FIG. 5, each air bag 90 may comprise an upper layer 92, a middle layer 94, and an upper layer 96 of suitable sheet material, each substantially coextensive with the others. Upper layer 92 and middle layer 94 encapsulate a first pressurization chamber 98, while middle layer 94 and lower layer 96 define a second pressurization chamber 100.

Upper layer 92 is provided with multiple opaque strips 102 that are interleaved or alternate with transparent strips 104. Middle layer 94 is likewise provided with multiple opaque strips 106 interleaved or alternating with multiple transparent strips 108. The strips 106 and 108 of middle layer 94 are laterally staggered with respect to strips 102 and 104 of upper layer 92 so that in a fully collapsed condition of pressurization chamber 98 and a concomitantly fully expanded configuration of pressurization chamber 100, shown in FIG. 6, opaque strips 102 and 106 are disposed side-by-side to cover transparent strips 104 and 108 and thereby effectively block incoming solar radiation 110. Strips 102 and 106 radiate energy as reflected or reemitted radiation 112. Such a roof configuration would be used, for example, in hot weather to reduce the heating of walkways 18, 20, 22, 24 by sunlight.

As illustrated in FIG. 5, pressurization chamber 98 may be expanded and pressurization chamber 100 concomitantly deflated to separate layers 92 and 94 and permit the entry of sunlight 114 through transparent strips 104 and 108. Such a roof configuration would be used, for example, in cooler weather to increase the heating of walkways 18, 20, 22, 24 by sunlight. Roof balloons or air bags 90 are another feature of climate control that serves to reduce the overall energy used by mall 12.

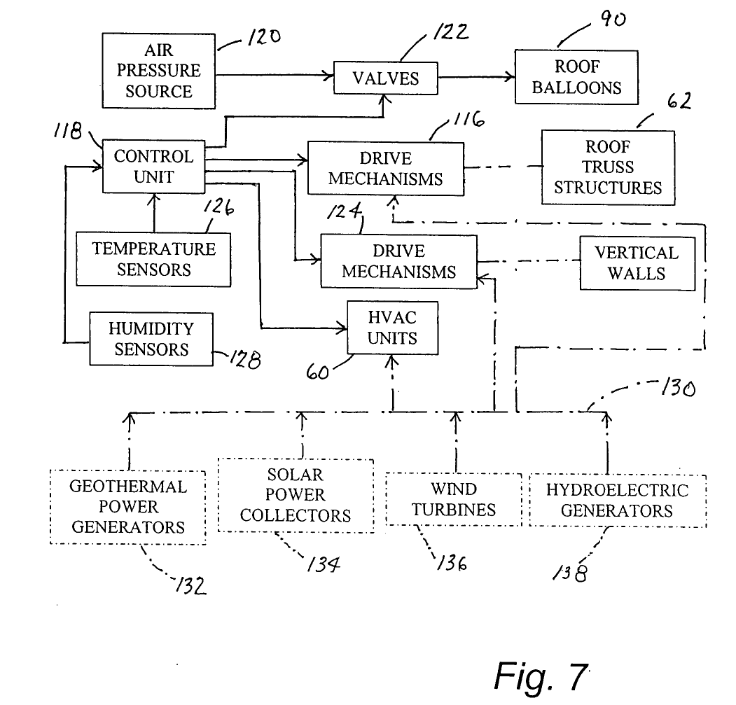

As depicted in FIG. 7, shopping facility or mall 12 further comprises a plurality of drive mechanisms 116 in turn operatively coupled to respective roof structures 62 for alternately shifting the roof structures in and out of vertically alignment with streets 14 and 16. A control unit 118 is operatively connected to drive mechanisms 116 for activating the same to shift the roof structures 62 from open positions (FIG. 2C or 2B) to closed positions (FIG. 2A) at an onset of inclement weather and to shift the roof structures from the closed positions to the open positions upon a termination of inclement weather. In addition, HVAC or air temperature control system 60 communicates with enclosed streets 14 and 16 and walkways 18, 20, 22, and 24 for maintaining the enclosed spaces within a predetermined temperature range while the roof structures 62 are in the closed positions (FIG. 2A.

As further depicted in FIG. 7, a source 120 of air pressure such as a compressor or pump may be alternately coupled to pressurization chambers 98 and 100 via multiple valves 122 under the control of control unit or microprocessor 118. Also, control unit 118 is coupled to a further gang of drive mechanisms 124 in turn linked to vertical walls 80, 82, 84, 86 for shifting those walls to open or close off streets 14 and 16, as discussed above. Control unit 118 may operate drive mechanisms 116 and 124, valves 122, and HVAC units 60 in response to human commands input via a keyboard, keypad, mouse, or other interface device (none illustrated).

Alternatively, control unit 118 may operate in accordance with a preprogrammed schedule and in response to signals from a web of temperature sensors 126, humidity sensors 128, and other detectors of climate conditions. “Green” power may be provided by a grid 130 comprising geothermal power generators 132, solar power collectors 134, wind turbines 136, and hydroelectric generators 138. Grid 130 may be part of a larger grid or a dedicated grid serving mall 12 only.

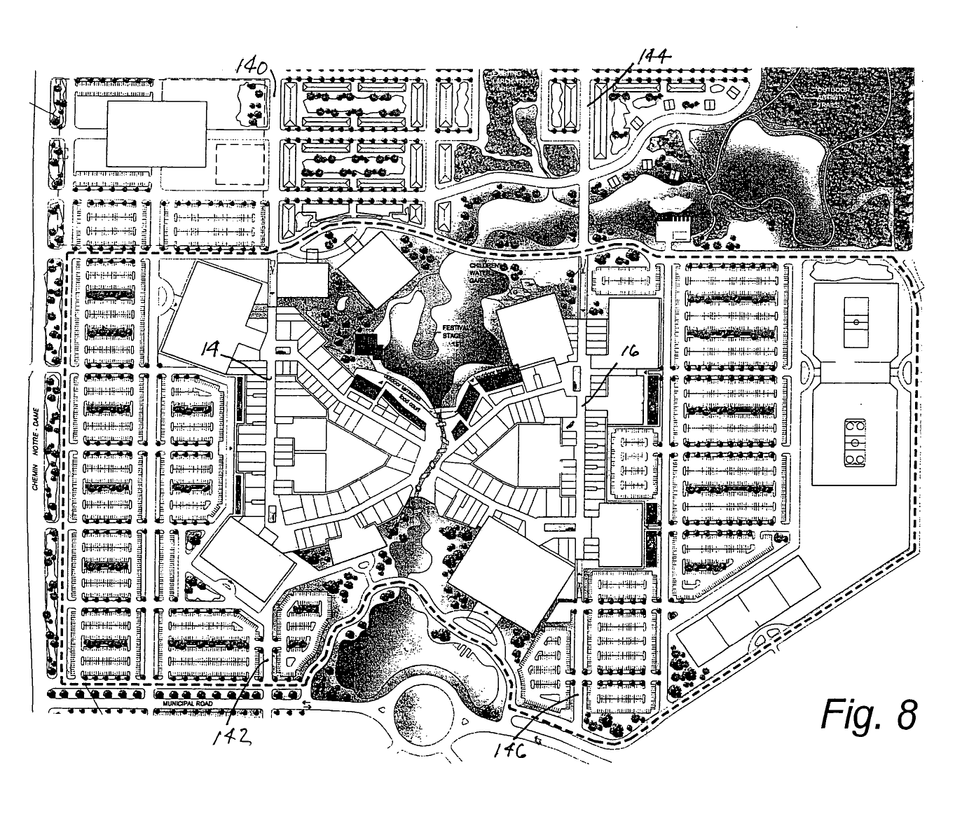

FIG. 8 shows mall 12 in a larger landscape, showing how streets 14 and 16 are continuations of local roadways 140 and 142 on one side and roads 144 and 146 on another side.

A stream 148 flows through atrium space 28, which is provided with pedestrian bridges 150. Atrium 128 may be covered by a trusswork dome (not shown) with polycarbonate roof panels and held in place by tree-like support columns (not shown) each with multiple branch bifurcations. Further doors 152 and 154 provided at atrium 128 may be open during pleasant weather and closed during inclement weather.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A method for operating a retail shopping facility comprising a plurality of retail spaces defined by respective enclosures and having respective store fronts disposed along a pedestrian right of way, said method comprising:
maintaining said pedestrian right of way open to the ambient environment during hospitable weather conditions;
enclosing said pedestrian right of way to form an enclosed common space upon a passing of a temperature threshold by ambient temperatures; and
while said pedestrian right of way is enclosed, operating an air temperature control system to maintain said enclosed common space within a predetermined temperature range.

2. The method defined in claim 1 wherein the enclosing of said pedestrian right of way includes automatically shifting a roof structure from a neutral position to a position covering said pedestrian right of way.

3. The method defined in claim 2 wherein the shifting of said roof structure includes moving said roof structure along rails.

4. The method defined in claim 2 wherein the enclosing of said pedestrian right of way further includes forming vertical walls closing ends of said pedestrian right of way.

5. A retail shopping facility comprising:
a plurality of retail spaces defined by respective enclosures and having respective store fronts disposed along a pedestrian right of way;
a roof structure shiftable between a closed position wherein at least part of said roof structure extends over said pedestrian right of way to enclose said pedestrian right of way along an upper side thereof and an open position wherein said roof structure is disposed out of vertical alignment with said pedestrian right of way, whereby said pedestrian right of way is open to the ambient environment from above; a drive mechanism operatively coupled to said roof structure;
a control unit operatively connected to said drive mechanism for activating same to shift said roof structure from said open position to said closed position at an onset of inclement weather and to shift said roof structure from said closed position to said open position upon a termination of inclement weather; and
an air temperature control system communicating with pedestrian right of way for maintaining same within a predetermined temperature range, while said roof structure is in said closed position.

6. The shopping facility defined in claim 5 wherein said pedestrian right of way is a first pedestrian right of way, further comprising: a plurality of additional retail spaces defined by respective enclosures and having respective store fronts disposed along a second pedestrian right of way communicating with said first pedestrian right of way;
an additional roof structure permanently disposed over said second right of way, said second pedestrian right of way being open to the ambient environment during hospitable weather; and means for isolating said second pedestrian right of way from the ambient environment upon occasions of inclement weather, said air temperature control system communicating with second pedestrian right of way for maintaining same together with said first pedestrian right of way within said predetermined temperature range

7. The shopping facility defined in claim 6 wherein said additional roof structure includes a balloon structure with at least two substantially co-extensive sheets or film members, a pressurization source being connected to said balloon structure for alternately pressurizing and depressurizing a space between said sheets or film members.

8. The shopping facility defined in claim 5 wherein said air temperature control system includes an environmentally friendly energy source.

9. The shopping facility defined in claim 8 wherein said energy source is taken from the group consisting of solar energy collectors, wind power generators, geothermal power generators, and hydroelectric turbines.

10. The shopping facility defined in claim 5 wherein said roof structure is at least partially disposed on at least some of said enclosures.

11. The shopping facility defined in claim 5 wherein said roof structure is disposed on plurality of rails.

12. The shopping facility defined in claim 5, further comprising vertical wall structures movably disposed to alternately open and close off ends of said pedestrian right of way.

13. The shopping facility defined in claim 5 wherein said pedestrian right of way is a street, including a road surface and at least one pedestrian walkway.
